(19) United States
(12) Patent Application Publication
(10) Pub. No.: US 2019/0342154 A1
(43) Pub. Date: Nov. 7, 2019

(54) METHOD OF CONNECTING AND PROCESSING NEW DEVICE DATA WITHOUT ANY SOFTWARE CODE CHANGES ON A MOBILE APPLICATION OR HUB

(71) Applicant: Flex Ltd., Singapore (SG)

(72) Inventors: Anoop Krishnan Nair, Dallas, TX (US); Venkata Rakesh Pachawa, McKinney, TX (US); Vrunjal Mehta, Frisco, TX (US); Amit Jain, Plano, TX (US)

(21) Appl. No.: 16/394,287

(22) Filed: Apr. 25, 2019

Related U.S. Application Data
(60) Provisional application No. 62/666,558, filed on May 3, 2018.

(51) Int. Cl. H04L 12/24; G06F 9/451; H04L 29/06; G06F 16/25; H04L 12/66; H04L 29/08

(52) U.S. Cl. CPC H04L 41/082; G06F 9/451; H04L 63/029; H04L 67/141; H04L 12/66; H04L 67/12; G06F 16/258

(57) ABSTRACT

Embodiments of the disclosure provide systems and methods for utilizing new connected Internet of Things (IoT) devices without software updates to the IoT gateways or mobile devices. According to one embodiment, a method for configuring an Internet of Things (IoT) device can comprise connecting, by a gateway device, with the IoT device and a configuration service in response to discovery of the IoT device. The gateway device can comprise, for example, a mobile device executing a gateway application. Configuration data for the IoT device can be acquired by the gateway device. The configuration data can comprise one or more expressions for converting data from the IoT device to a predefined data model based on one or more characteristics of the data from the IoT device. The gateway device can apply the acquired configuration data for the IoT device and process notifications from the IoT device using the applied configuration data.

### CROSS REFERENCE TO RELATED APPLICATION

The present application claims the benefits of and priority, under 35 U.S.C. § 119(e), to U.S. Provisional Application No. 62/666,558 filed May 3, 2018 by Nair et al and entitled “A Method of Connecting and Processing New Device Data Without Any Software Code Changes on a Mobile Application of Hub” of which the entire disclosure is incorporated herein by reference for all purposes.

### FIELD OF THE DISCLOSURE

Embodiments of the present disclosure relate generally to methods and systems for Internet of Things (IoT) gateways and mobile devices and more particularly to utilizing new connected IoT devices without software updates to the IoT gateways or mobile devices.

### BACKGROUND

Current Internet of Things (IoT) gateways and mobile devices support new IoT devices by updating to a new software that includes the code changes to discover and process data from these devices. The IoT standards are very fragmented and do not cover the vast use cases for which IoT devices are built. Accordingly, it is difficult to cover every use case in the first software deployments and initial revisions.

Moreover, the IoT universe is seeing a mass proliferation of devices that are connected via a mobile phone or hub to the cloud. IoT standards are fragmented and the use cases for IoT devices are also very unique and diverse, thus preventing any standard frameworks from supporting every kind of device. New devices with new functionalities are being added very quickly. Moreover, infrastructure is challenged to keep up with this pace. Hence, there is a need for improved methods and systems for supporting new devices and configuration changes without updating software on the end gateways, hubs, or mobile device.

### BRIEF SUMMARY

Embodiments of the disclosure provide systems and methods for utilizing new connected Internet of Things (IoT) devices without software updates to the IoT gateways or mobile devices. According to one embodiment, a method for configuring an Internet of Things (IoT) device can comprise connecting, by a gateway device, with the IoT device and a configuration service in response to discovery of the IoT device. The gateway device can comprise, for example, a mobile device executing a gateway application. Configuration data for the IoT device can be acquired by the gateway device. The configuration data can comprise one or more expressions for converting data from the IoT device to a predefined data model based on one or more characteristics of the data from the IoT device. The gateway device can apply the acquired configuration data for the IoT device and process notifications from the IoT device using the applied configuration data.

Connecting with the IoT device and the configuration service in response to discovery of the IoT device and acquiring configuration data for the IoT device can further comprise requesting, by the gateway device, from the configuration service, the configuration data for the IoT device. The gateway device can receive, from the configuration service, the requested configuration data for the IoT device. Using the received configuration data, the gateway device can connect with the IoT device.

Applying the acquired configuration data for the IoT device can comprise requesting, by the gateway device, initial data from the IoT device and receiving the requested initial data from the IoT device. The gateway device can parse the received initial data based on characteristics of data from the IoT device defined in the acquired configuration data. An expression of the one or more expressions for converting data from the IoT device to the predefined data model can be defined in the configuration data obtained by the gateway device based on the received initial data. The gateway device can then evaluate the obtained expression using the parsed initial data, wherein evaluating the obtained expression produces update data. The update data produced from evaluating the obtained expression can then be sent by the gateway device to the configuration service.

Processing notifications from the IoT device using the applied configuration data can comprise receiving, by the gateway device, a notification from the IoT device. The notification can comprise operating data from the IoT device. The gateway device can parse the received operating data based on characteristics of data from the IoT device defined in the acquired configuration data. An expression of the one or more expressions for converting data from the IoT device to the predefined data model defined in the configuration data can be obtained by the gateway device based on the received operating data. The gateway device can then evaluate the obtained expression using the parsed operating data, wherein evaluating the obtained expression produces update data. The update data produced from evaluating the obtained expression can then be sent by the gateway device to the configuration service.

In some cases, the configuration data can additionally, or alternatively, comprise user interface configuration data. For example, the configuration data can define a representation of the IoT device on a user interface of the gateway device. In some cases, the configuration data can further define a plurality of different renderings for the representation of the IoT device on the user interface of the gateway device based on characteristics of data received from the IoT device.

According to another embodiment, a gateway device can comprise a processor and a memory coupled with and readable by the processor. The memory can store therein a set of instructions which, when executed by the processor, further cause the processor to configure an IoT device by connecting with the IoT device and a configuration service in response to discovery of the IoT device and acquiring configuration data for the IoT device. The configuration data can comprise one or more expressions for converting data from the IoT device to a predefined data model based on one or more characteristics of the data from the IoT device. The gateway device can apply the acquired configuration data for the IoT device and process notifications from the IoT device using the applied configuration data. In some cases, the gateway device can comprise, for example, a mobile device executing a gateway application.

Connecting with the IoT device and the configuration service in response to discovery of the IoT device and acquiring configuration data for the IoT device can further comprise requesting, by the gateway device, from the configuration service, the configuration data for the IoT device. The gateway device can receive, from the configuration service, the requested configuration data for the IoT device. Using the received configuration data, the gateway device can connect with the IoT device.

Applying the acquired configuration data for the IoT device can comprise requesting, by the gateway device, initial data from the IoT device and receiving the requested initial data from the IoT device. The gateway device can parse the received initial data based on characteristics of data from the IoT device defined in the acquired configuration data. An expression of the one or more expressions for converting data from the IoT device to the predefined data model can be defined in the configuration data obtained by the gateway device based on the received initial data. The gateway device can then evaluate the obtained expression using the parsed initial data, wherein evaluating the obtained expression produces update data. The update data produced from evaluating the obtained expression can then be sent by the gateway device to the configuration service.

Processing notifications from the IoT device using the applied configuration data can comprise receiving, by the gateway device, a notification from the IoT device. The notification can comprise operating data from the IoT device. The gateway device can parse the received operating data based on characteristics of data from the IoT device defined in the acquired configuration data. An expression of the one or more expressions for converting data from the IoT device to the predefined data model defined in the configuration data can be obtained by the gateway device based on the received operating data. The gateway device can then evaluate the obtained expression using the parsed operating data, wherein evaluating the obtained expression produces update data. The update data produced from evaluating the obtained expression can then be sent by the gateway device to the configuration service.

In some cases, the configuration data can additionally, or alternatively, comprise user interface configuration data. For example, the configuration data can define a representation of the IoT device on a user interface of the gateway device. In some cases, the configuration data can further define a plurality of different renderings for the representation of the IoT device on the user interface of the gateway device based on characteristics of data received from the IoT device

According to yet another embodiment, a non-transitory, computer-readable medium can comprise a set of instructions stored therein which, when executed by a processor, causes a processor to configure an IoT device by connecting with the IoT device and a configuration service in response to discovery of the IoT device and acquiring configuration data for the IoT device. The configuration data can comprise one or more expressions for converting data from the IoT device to a predefined data model based on one or more characteristics of the data from the IoT device. The instructions can further cause the processor to apply the acquired configuration data for the IoT device and process notifications from the IoT device using the applied configuration data.

Connecting with the IoT device and the configuration service in response to discovery of the IoT device and acquiring configuration data for the IoT device can further comprise requesting, by the gateway device, from the configuration service, the configuration data for the IoT device. The gateway device can receive, from the configuration service, the requested configuration data for the IoT device. Using the received configuration data, the gateway device can connect with the IoT device.

Applying the acquired configuration data for the IoT device can comprise requesting, by the gateway device, initial data from the IoT device and receiving the requested initial data from the IoT device. The gateway device can parse the received initial data based on characteristics of data from the IoT device defined in the acquired configuration data. An expression of the one or more expressions for converting data from the IoT device to the predefined data model can be defined in the configuration data obtained by the gateway device based on the received initial data. The gateway device can then evaluate the obtained expression using the parsed initial data, wherein evaluating the obtained expression produces update data. The update data produced from evaluating the obtained expression can then be sent by the gateway device to the configuration service.

Processing notifications from the IoT device using the applied configuration data can comprise receiving, by the gateway device, a notification from the IoT device. The notification can comprise operating data from the IoT device. The gateway device can parse the received operating data based on characteristics of data from the IoT device defined in the acquired configuration data. An expression of the one or more expressions for converting data from the IoT device to the predefined data model defined in the configuration data can be obtained by the gateway device based on the received operating data. The gateway device can then evaluate the obtained expression using the parsed operating data, wherein evaluating the obtained expression produces update data. The update data produced from evaluating the obtained expression can then be sent by the gateway device to the configuration service.

In some cases, the configuration data can additionally, or alternatively, comprise user interface configuration data. For example, the configuration data can define a representation of the IoT device on a user interface of the gateway device. In some cases, the configuration data can further define a plurality of different renderings for the representation of the IoT device on the user interface of the gateway device based on characteristics of data received from the IoT device.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating elements of an exemplary Internet of Things (IoT) environment in which embodiments of the present disclosure may be implemented.

FIG. 4 is a block diagram illustrating elements of exemplary IoT device configuration data according to one embodiment of the present disclosure.

FIG. 5 is a flowchart illustrating an exemplary process for configuring an IoT device according to one embodiment of the present disclosure.

FIG. 6 is a flowchart illustrating an exemplary process for connecting with an IoT device according to one embodiment of the present disclosure.

FIG. 7 is a flowchart illustrating an exemplary process for acquiring and applying update data for an IoT device according to one embodiment of the present invention.

FIG. 8 is a flowchart illustrating an exemplary process for processing notifications from an IoT device according to one embodiment of the present invention.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only, and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programmable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, objective C for iphone, Java for Android, C/C++ for Linux or other operating systems, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

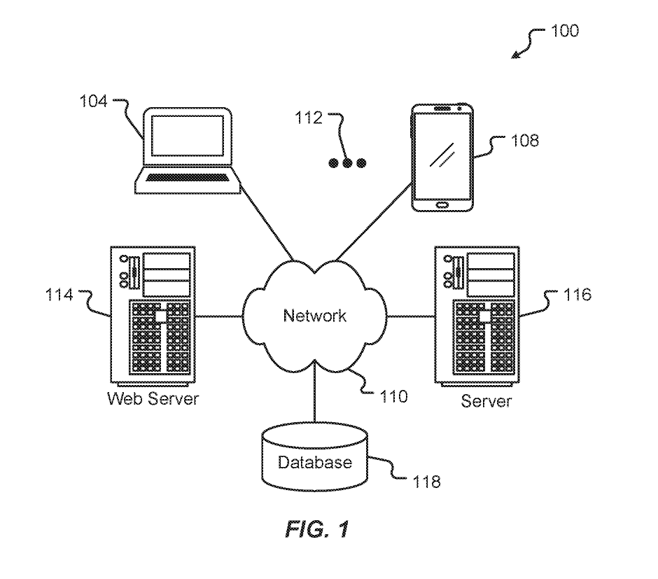

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

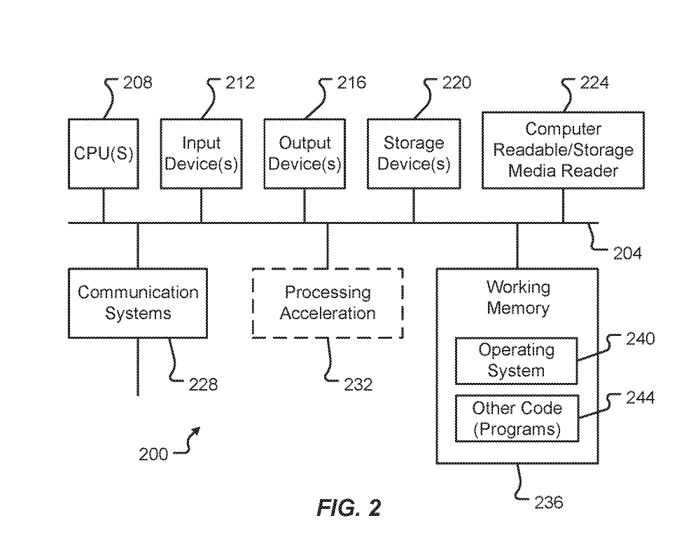

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

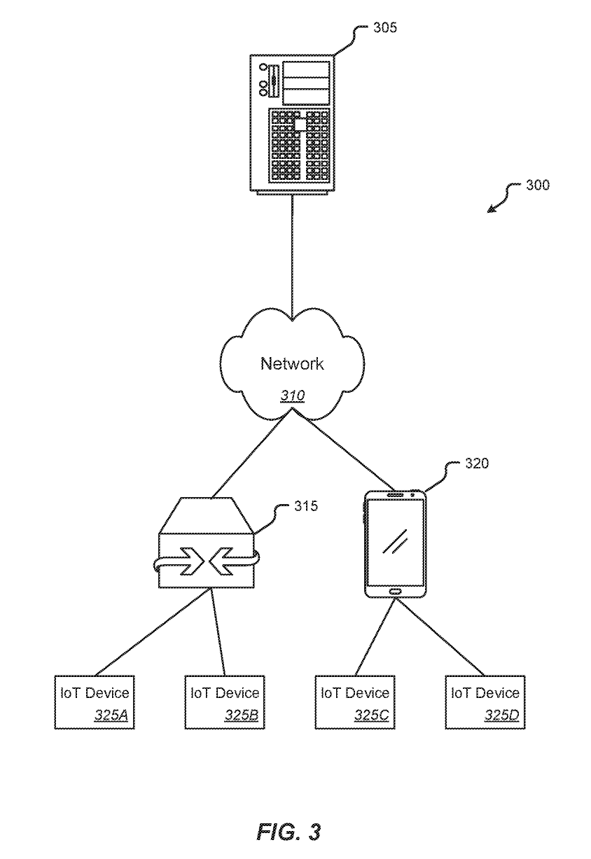

FIG. 3 is a block diagram illustrating elements of an exemplary Internet of Things (IoT) environment in which embodiments of the present disclosure may be implemented. As illustrated in this example, the system 300 can comprise a configuration service 305 provided by one or more servers such as any of the servers described above. The configuration service 305 can be provided, for example, by a manufacturer of one or more devices as will be described or by a third-party. The configuration service 305 can be communicatively coupled with and accessible through one or more networks 310 such as the Internet and/or any one or more other networks as described above. Also connected with the network 310 can be a gateway device 315 and a mobile device 320. The gateway device 315 can comprise a hub, WiFi access point, or similar device as known in the art and which provides access to the network 310 for local device or a LAN such as a home network etc. For example, the gateway device 315 can provide Internet access to one or more IoT devices 325A and 325B wired or wireless connected with the gateway device 315. The mobile device 320 can comprise a mobile telephone, tablet, or other portable computing device. According to one embodiment, the mobile device 320 can execute an application to provide functionality such as provide by the gateway device 315. Therefore, the mobile device 320 can act as a gateway device for one or more IoT devices 325C and 325D communicatively coupled therewith, e.g., via BluTooth, WiFi, or other means. As used herein, the term gateway device should be considered to mean either a dedicated hub or other network connected device acting as a gateway 315 or a mobile device 320 executing an application that provides the functions of a gateway.

According to one embodiment, the gateway device 315 and/or mobile device 320 can be adapted to recognize and operate with various IoT devices 325A-325D of different types, even when a new, previously unknown IoT device is added and even if that new device utilizes different data formats. As described herein, this can be accomplished without a need to update the software executing on the gateway device 315 or mobile device 320 but rather, by obtaining configuration data for the new device from the configuration service 305. This configuration data can then be used by the gateway device 315 or mobile device 320 to convert the data from the IoT device into a standardized data model.

More specifically, the configuration service 305 can maintain a set of configuration information for each of a variety of different IoT devices. The configuration data can comprise one or more expressions for converting data from the IoT device to a predefined data model based on one or more characteristics of the data from the IoT device. Upon detection of a new IoT device 325A-325D, the gateway 315 or mobile device 320 can request the configuration information for that device from the configuration service 305. The gateway device 315 or mobile device 320 can apply the acquired configuration data from the IoT device 325A-325D, i.e., by evaluating the expression(s) therein to convert the data from the IoT device 325A-325D to the standardized data model but without requiring code changes to the gateway device 315 or mobile device 320.

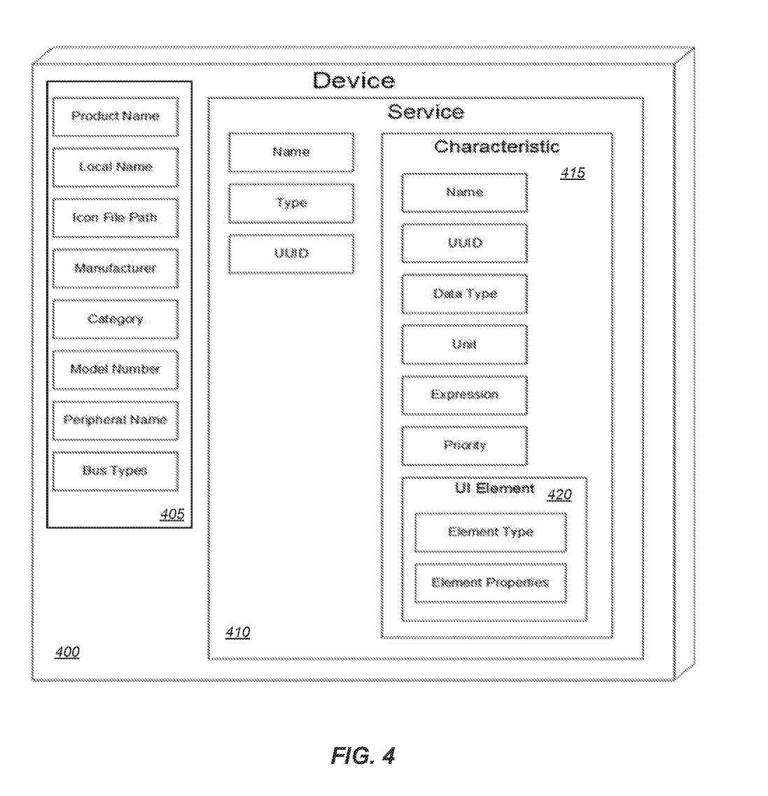

FIG. 4 is a block diagram illustrating elements of exemplary IoT device configuration data according to one embodiment of the present disclosure. More specifically, this example illustrates a set of configuration data 400 for an IoT device as may be maintained by the configuration service 305 and retrieved gateway device 315 and/or mobile device 320 as described above. As shown here, the configuration data 400 can include a set of metadata 405 for the device. This metadata 405 can include, but is not limited to, a Product Name tag defining a name of the device, a Local Name tag defining a name of the device used to identify the device in Bluetooth Scan, an Icon File Path tag defining a file path or location from where an icon or other user interface representation for this device can be downloaded, a Manufacturer tag identifying a company that manufactured the device, a Category tag defining a category of the device, e.g., medical, wearable, etc., a Model Number tag identifying a device model number, a Peripheral Name defining a name of the device to be shown on the user interface, and/or one or more Bus Types tags identifying connection types supported by the device, BLE, WiFi, etc.

The configuration data 400 can also include service definition data 410 for one or more services supporting the device. It should be noted and understood that while only one set of service definition data 410 is shown here for the sake of simplicity and clarity, additional services can be defined depending upon the device and the exact implementations. Each set of service definition data 410 can include, but is not limited to, data defining a Name of the service, a Type of the service, and/or a UUID or other unique identifier of the service. A set of characteristics 415 or properties can also be defined for each service. For example, these characteristics 415 can include, but are not limited to, a Name defining a name of the characteristic or property, a UUID or other unique identifier of the characteristic or property, a definition of a Data Type of the value sent from the device, e.g., string, integer, float, etc., a definition of units of the measurement of the data, one or more Expression, e.g., regular expressions, scripts, etc., to be evaluated or executed when parsing and/or applying the configuration data to the data from device, a definition of a Priority for the characteristic or property for display on a user interface of the gateway or mobile device. In some cases, the characteristics 415 or properties can also define a UI Element object 420 encapsulating and defining UI Element properties for the element displayed on the user interface of the gateway or mobile device.

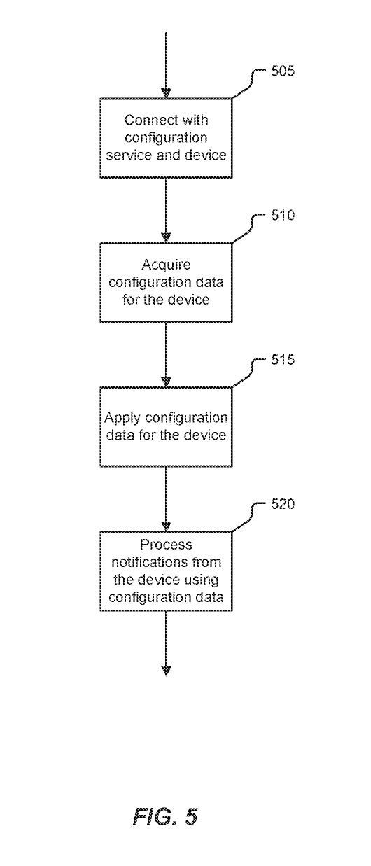

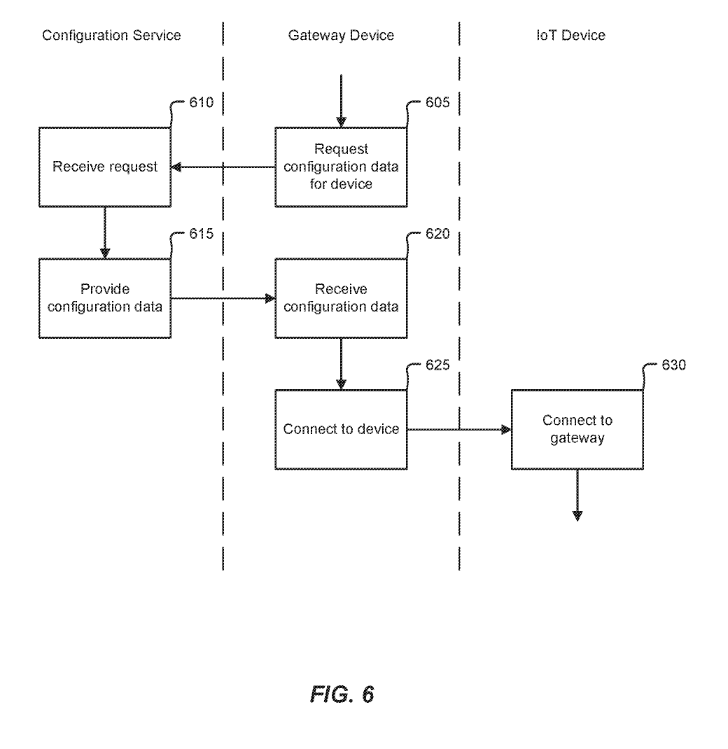

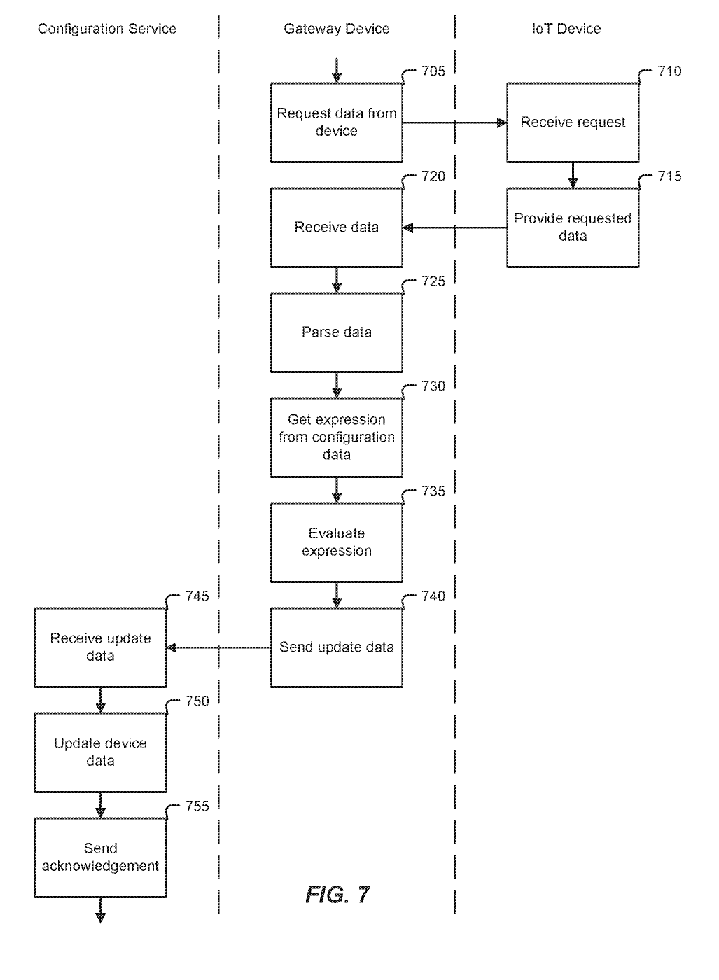

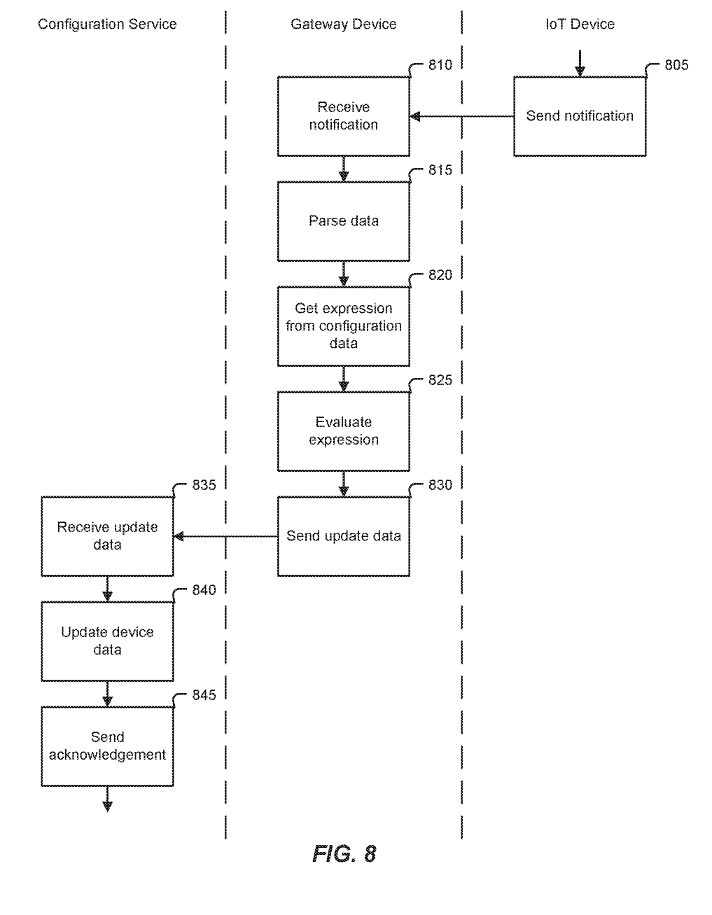

FIG. 5 is a flowchart illustrating an exemplary process for configuring an IoT device according to one embodiment of the present disclosure. As illustrated in this example, configuring an IoT device can comprise connecting 505, by a gateway device, with the IoT device and a configuration service in response to discovery of the IoT device. Configuration data for the IoT device can be acquired 510 by the gateway device. The configuration data can comprise one or more expressions for converting data from the IoT device to a predefined data model based on one or more characteristics of the data from the IoT device. Additional details of an exemplary process for connecting 505 with the IoT device and configuration service and acquiring 510 configuration data will be described below with reference to FIG. 6. The gateway device can apply 515 the acquired configuration data for the IoT device and process 520 notifications from the IoT device using the applied configuration data. Additional details of exemplary processes for applying 515 the configuration data and processing 520 notifications will be described below with reference to FIGS. 7 and 8 respectively.

FIG. 6 is a flowchart illustrating an exemplary process for connecting with an IoT device according to one embodiment of the present disclosure. As illustrated in this example, connecting with the IoT device and the configuration service in response to discovery of the IoT device and acquiring configuration data for the IoT device can begin with the gateway device requesting 605 the configuration data for the IoT device from the configuration service. The configuration service can receive 610 this request and respond by providing 615 the requested configuration data. The gateway device can receive 620 the requested configuration data for the IoT device from the configuration service and, using the received configuration data, the can connect 625 and 630 with the IoT device.

FIG. 7 is a flowchart illustrating an exemplary process for acquiring and applying update data for an IoT device according to one embodiment of the present invention. As illustrated in this example, applying the acquired configuration data for the IoT device can begin with the gateway device requesting 705 initial data from the IoT device. The IoT device can receive 710 this request and respond by providing 715 the requested data. The gateway device can receive 720 the initial data from the IoT device and parse 725 the received initial data based on characteristics of data from the IoT device defined in the acquired configuration data. An expression of the one or more expressions for converting data from the IoT device to the predefined data model defined in the configuration data can be obtained 730 or selected by the gateway device based on the received initial data. The gateway device can then evaluate 735 the obtained expression using the parsed initial data. Evaluating 735 the obtained expression can produce update data according to the defined model. The update data produced from evaluating the obtained expression can then be sent 740 by the gateway device to the configuration service. The configuration service can receive 745 the update data, update 750 device data maintained by the configuration service based on the received update data, and may send 755 an acknowledgement of the update to the gateway device.

FIG. 8 is a flowchart illustrating an exemplary process for processing notifications from an IoT device according to one embodiment of the present invention. As illustrated in this example, processing notifications from the IoT device using the applied configuration data can begin with the IoT device sending 805 and the gateway device receiving 810 a notification. The notification can comprise operating data from the IoT device. The gateway device can parse 815 the received operating data based on characteristics of data from the IoT device defined in the acquired configuration data. An expression of the one or more expressions for converting data from the IoT device to the predefined data model defined in the configuration data can be obtained 820 or selected by the gateway device based on the received operating data. The gateway device can then evaluate 825 the obtained expression using the parsed operating data. Evaluating 825 the obtained expression can produce update data. The update data produced from evaluating the obtained expression can then be sent 830 by the gateway device to the configuration service. The configuration service can receive 835 the update data, update 840 device data maintained by the configuration service based on the received update data, and may send 845 an acknowledgement of the update to the gateway device.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for configuring an Internet of Things (IoT) device, the method comprising:
connecting, by a gateway device, with the IoT device and a configuration service in response to discovery of the IoT device;
acquiring, by the gateway device, configuration data for the IoT device, the configuration data comprising one or more expressions for converting data from the IoT device to a predefined data model based on one or more characteristics of the data from the IoT device;
applying, by the gateway device, the acquired configuration data for the IoT device; and
processing, by the gateway device, notifications from the IoT device using the applied configuration data.

2. The method of claim 1, wherein connecting with the IoT device and the configuration service in response to discovery of the IoT device and acquiring configuration data for the IoT device further comprises:
requesting, by the gateway device, from the configuration service, the configuration data for the IoT device;
receiving, by the gateway device, from the configuration service, the requested configuration data for the IoT device; and
connecting, by the gateway device, with the IoT device, using the received configuration data.

3. The method of claim 2, wherein applying the acquired configuration data for the IoT device comprises:
requesting, by the gateway device, initial data from the IoT device;
receiving, by the gateway device, the requested initial data from the IoT device;
parsing, by the gateway device, the received initial data based on characteristics of data from the IoT device defined in the acquired configuration data;
obtaining, by the gateway device, an expression of the one or more expressions for converting data from the IoT device to the predefined data model defined in the configuration data based on the received initial data;
evaluating, by the gateway device, the obtained expression using the parsed initial data, wherein evaluating the obtained expression produces update data; and
sending, by the gateway device, to the configuration service, the update data produced from evaluating the obtained expression.

4. The method of claim 3, wherein processing notifications from the IoT device using the applied configuration data comprises:
receiving, by the gateway device, a notification from the IoT device, the notification comprising operating data from the IoT device;
parsing, by the gateway device, the received operating data based on characteristics of data from the IoT device defined in the acquired configuration data;
obtaining, by the gateway device, an expression of the one or more expressions for converting data from the IoT device to the predefined data model defined in the configuration data based on the received operating data;
evaluating, by the gateway device, the obtained expression using the parsed operating data, wherein evaluating the obtained expression produces update data; and
sending, by the gateway device, to the configuration service, the update data produced from evaluating the obtained expression.

5. The method of claim 1, wherein the configuration data further comprises user interface configuration data defining a representation of the IoT device on a user interface of the gateway device.

6. The method of claim 5, wherein the configuration data further defines a plurality of different renderings for the representation of the IoT device on the user interface of the gateway device based on characteristics of data received from the IoT device.

7. The method of claim 1, wherein the gateway device comprises a mobile device executing a gateway application.

8. A gateway device comprising:
a processor; and
a memory coupled with and readable by the processor and storing therein a set of instructions which, when executed by the processor, further cause the processor to configure an Internet of Things (IoT) device by:
connecting with the IoT device and a configuration service in response to discovery of the IoT device;
acquiring configuration data for the IoT device, the configuration data comprising one or more expressions for converting data from the IoT device to a predefined data model based on one or more characteristics of the data from the IoT device;
applying the acquired configuration data for the IoT device; and
processing notifications from the IoT device using the applied configuration data.

9. The gateway device of claim 8, wherein connecting with the IoT device and the configuration service in response to discovery of the IoT device and acquiring configuration data for the IoT device further comprises:
requesting, from the configuration service, the configuration data for the IoT device;
receiving, from the configuration service, the requested configuration data for the IoT device; and
connecting with the IoT device using the received configuration data.

10. The gateway device of claim 9, wherein applying the acquired configuration data for the IoT device comprises:
requesting initial data from the IoT device;
receiving the requested initial data from the IoT device;
parsing the received initial data based on characteristics of data from the IoT device defined in the acquired configuration data;
obtaining an expression of the one or more expressions for converting data from the IoT device to the predefined data model defined in the configuration data based on the received initial data;
evaluating the obtained expression using the parsed initial data, wherein evaluating the obtained expression produces update data; and
sending, to the configuration service, the update data produced from evaluating the obtained expression.

11. The gateway device of claim 10, wherein processing notifications from the IoT device using the applied configuration data comprises:
receiving a notification from the IoT device, the notification comprising operating data from the IoT device;
parsing the received operating data based on characteristics of data from the IoT device defined in the acquired configuration data;
obtaining an expression of the one or more expressions for converting data from the IoT device to the predefined data model defined in the configuration data based on the received operating data;
evaluating the obtained expression using the parsed operating data, wherein evaluating the obtained expression produces update data; and
sending, to the configuration service, the update data produced from evaluating the obtained expression.

12. The gateway device of claim 8, wherein the configuration data further comprises user interface configuration data defining a representation of the IoT device on a user interface of the gateway device.

13. The gateway device of claim 12, wherein the configuration data further defines a plurality of different renderings for the representation of the IoT device on the user interface of the gateway device based on characteristics of data received from the IoT device.

14. The gateway device of claim 8, wherein the gateway device comprises a mobile device executing a gateway application.

15. A non-transitory, computer-readable medium comprising a set of instructions stored therein which, when executed by a processor, causes a processor to configure an Internet of Things (IoT) device by:
connecting with the IoT device and a configuration service in response to discovery of the IoT device;
acquiring configuration data for the IoT device, the configuration data comprising one or more expressions for converting data from the IoT device to a predefined data model based on one or more characteristics of the data from the IoT device;
applying the acquired configuration data for the IoT device; and
processing notifications from the IoT device using the applied configuration data.

16. The non-transitory, computer-readable medium of claim 15, wherein connecting with the IoT device and the configuration service in response to discovery of the IoT device and acquiring configuration data for the IoT device further comprises:
requesting, from the configuration service, the configuration data for the IoT device;
receiving, from the configuration service, the requested configuration data for the IoT device; and
connecting with the IoT device using the received configuration data.

17. The non-transitory, computer-readable medium of claim 16, wherein applying the acquired configuration data for the IoT device comprises:
requesting initial data from the IoT device;
receiving the requested initial data from the IoT device;
parsing the received initial data based on characteristics of data from the IoT device defined in the acquired configuration data;
obtaining an expression of the one or more expressions for converting data from the IoT device to the predefined data model defined in the configuration data based on the received initial data;
evaluating the obtained expression using the parsed initial data, wherein evaluating the obtained expression produces update data; and
sending, to the configuration service, the update data produced from evaluating the obtained expression.

18. The non-transitory, computer-readable medium of claim 17, wherein processing notifications from the IoT device using the applied configuration data comprises:
receiving a notification from the IoT device, the notification comprising operating data from the IoT device;
parsing the received operating data based on characteristics of data from the IoT device defined in the acquired configuration data;
obtaining an expression of the one or more expressions for converting data from the IoT device to the predefined data model defined in the configuration data based on the received operating data;
evaluating the obtained expression using the parsed operating data, wherein evaluating the obtained expression produces update data; and
sending, to the configuration service, the update data produced from evaluating the obtained expression.

19. The non-transitory, computer-readable medium of claim 15, wherein the configuration data further comprises user interface configuration data defining a representation of the IoT device on a user interface of the gateway device.

20. The non-transitory, computer-readable medium of claim 19, wherein the configuration data further defines a plurality of different renderings for the representation of the IoT device on the user interface of the gateway device based on characteristics of data received from the IoT device.
